(19) United States
(12) Patent Application Publication
(10) Pub. No.: US 2017/0109336 A1
(43) Pub. Date: Apr. 20, 2017

(54) ANNOTATING TEXT USING EMOTIVE CONTENT AND MACHINE LEARNING

(71) Applicant: International Business Machines Corporation, Armonk, NY (US)

(72) Inventors: Nicholas V. Bruno, Cary, NC (US); Chung-Wei Hang, Cary, NC (US); Nisarga Markandaiah, Pittsburgh, PA (US); Jared M.D. Smythe, Fuquay Varina, NC (US)

(21) Appl. No.: 14/982,323

(22) Filed: Dec. 29, 2015

Related U.S. Application Data
(63) Continuation of application No. 14/887,501, filed on Oct. 20, 2015.

(51) Int. Cl. G06F 17/24; G06F 3/0487; G06F 17/27

(52) U.S. Cl. CPC G06F 17/241; G06F 17/273; G06F 17/279; G06F 3/0487

(57) ABSTRACT

A natural language text is received from a user. The natural language text includes typing characteristics metadata. An emotive content of the natural language text is determined using a machine learning model. The natural language text is modified based on the emotive content.

### BACKGROUND OF THE INVENTION

The present invention relates generally to text communications, and more particularly to annotating text based on the emotive content of the text and machine learning models.

Instant messaging provides a simple way to exchange real-time, text-based messages between collaborators who are connected to an on-line or electronic networking environment such as the Internets, intranets, and extranets. Originally, instant messaging was limited to the basic exchange of text. As technology has matured, additional functionally has been added including the integration of voice and video into chat sessions and also the use of emotional icons (emoticons) to visually represent the emotions experience by a chat collaborator.

Emoticons are well known in the world of electronic communications and have found use not only in instant messaging, but also in other modes of communication like e-mail. An emoticon is a metacommunicative pictorial representation of a facial expression or other body expression, in the absence of actual body language and prosody, that serves to draw attention to the tenor or temper of a message by changing or improving the interpretation of the message by the person who receives the message. As social media has become widespread, emoticons have played a significant role in communication. Emoticons offer a wide range of feelings through different types of gestures, especially facial gestures.

### SUMMARY

Embodiments of the present invention include a method, computer program product, and system for annotating natural language text based on the emotive content of the natural language text. In one embodiment, a natural language text is received from a user. The natural language text includes typing characteristics metadata. An emotive content of the natural language text is determined using a machine learning model. The natural language text is modified based on the emotive content.

### BRIEF DESCRIPTION OF THE DRAWINGS

FIG. 1 is a functional block diagram of a data processing environment, in accordance with an embodiment of the present invention;

FIG. 2 is a flowchart depicting operational steps for annotating natural language text based on the emotive content of the natural language text using machine learning models, in accordance with an embodiment of the present invention; and

FIG. 3 depicts a block diagram of components of the computer of FIG. 1, in accordance with an embodiment of the present invention.

### DETAILED DESCRIPTION

Embodiments of the present invention provide for modifications to text to include emotive content. Embodiments of the present invention include a machine learning model that predicts the emotive content to add annotations based on typing characteristics of the user while typing the text. Embodiments of the present invention include, based on user input regarding the predicted emotive content, updating a machine learning model. Embodiments of the present invention provide a standard machine learning model that can be applied to all users. Embodiments of the present invention provide a user specific machine learning model personalized for a specific user.

Embodiments of the present invention recognize that in text-based communication methods, there is an inherent lack of non-textual cues, such as emotive cues, voice intonation, moods, attitudes, body language, hand gestures, etc. Embodiments of the present invention recognize that this lack of non-textual cues may lead to miscommunication of the original text, such as misinterpreting of the intended message.

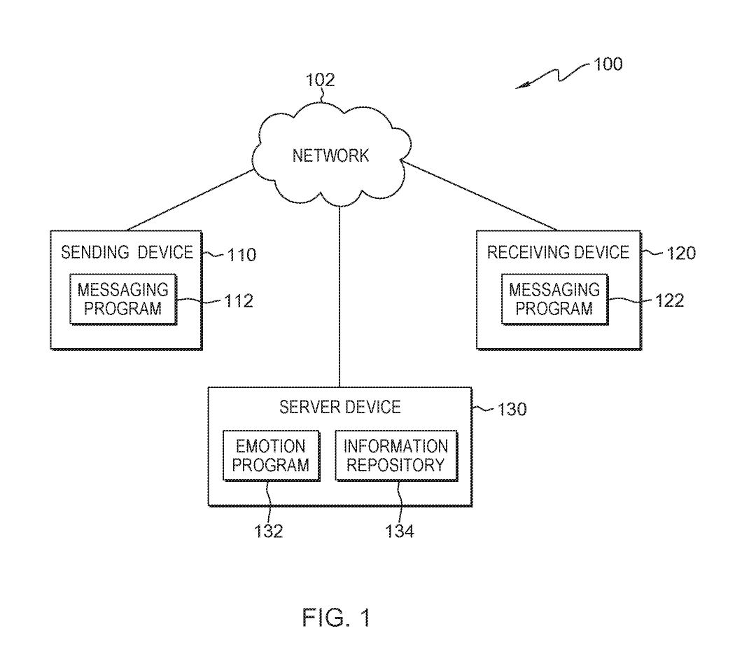

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments can be implemented. Many modifications to the depicted embodiment can be made by those skilled in the art without departing from the scope of the invention as recited by the claims.

An embodiment of data processing environment 100 includes sending device 110, receiving device 120, and server device 130, interconnected over network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between sending device 110, receiving device 120, server device 130 and any other computer connected to network 102, in accordance with embodiments of the present invention.

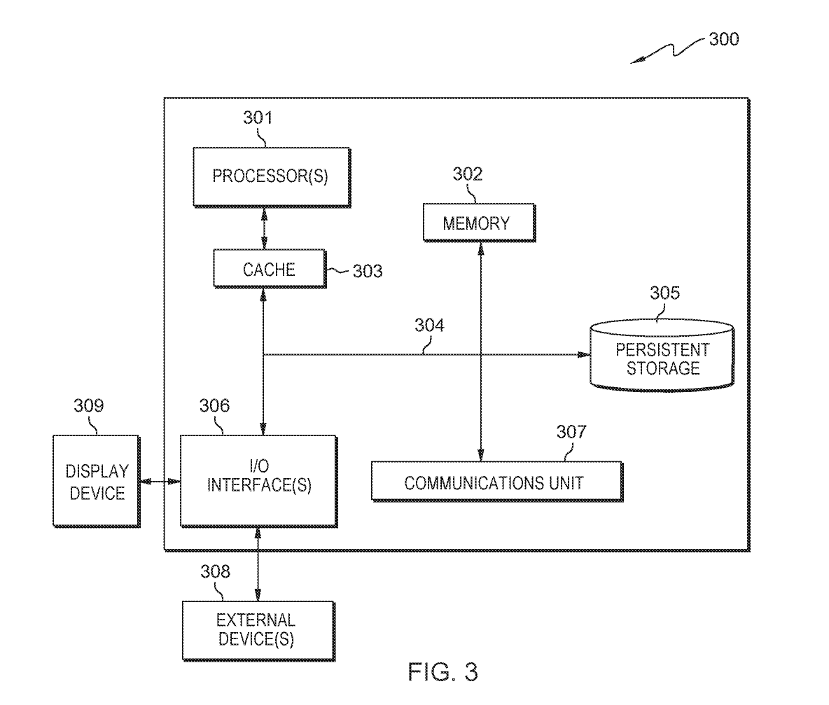

In example embodiments, sending device 110 can be a laptop, tablet, or netbook personal computer (PC), a desktop computer, a personal digital assistant (PDA), a smart phone, or any programmable electronic device capable of communicating with any computing device within data processing environment 100. In certain embodiments, sending device 110 collectively represents a computer system utilizing clustered computers and components (e.g., database server computers, application server computers, etc.) that act as a single pool of seamless resources when accessed by elements of data processing environment 100, such as in a cloud computing environment. In general, sending device 110 is representative of any electronic device or combination of electronic devices capable of executing computer readable program instructions. Sending device 110 can include components as depicted and described in further detail with respect to FIG. 3, in accordance with embodiments of the present invention. Receiving device 120 is substantially similar to sending device 110 and has substantially similar components.

In embodiments, sending device 110 includes messaging program 112. Messaging program 112 is a program, application, or subprogram of a larger program for communicating between devices. Messaging program 122 is substantially similar to messaging program 112.

Messaging program 112 is a program that allows for the communication with another program over the Internet or other types of networks. In other words, a user, via a user interface, inputs a message into messaging program 112 and messaging program 112 communicates this message over network 102 to messaging program 122, for viewing by a user. In an embodiment, messaging program 112 may be an instant messaging program, e-mail program, chat program, website, or any other program that allows for textual interaction. Messaging program 112 may have user login verification capabilities. Messaging program 112 may have the ability to communicate text, emoticons, pictures, audio, video, or any other media known in the art. Messaging program 112 may communicate metadata associated with the text-based communication. Messaging program 112 may communicate with messaging program 122 simultaneously (i.e., real time) or messaging program 112 may deliver the message to a storage device (not shown) for access by messaging program 122 at a later time than when the message was originally sent.

A user interface (not shown) is a program that provides an interface between a user and messaging program 112. A user interface refers to the information (such as graphic, text, and sound) a program presents to a user and the control sequences the user employs to control the program. There are many types of user interfaces. In one embodiment, the user interface can be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In example embodiments, server device 130 can be a laptop, tablet, or netbook personal computer (PC), a desktop computer, a personal digital assistant (PDA), a smart phone, or any programmable electronic device capable of communicating with any computing device within data processing environment 100. In certain embodiments, server device 130 collectively represents a computer system utilizing clustered computers and components (e.g., database server computers, application server computers, etc.) that act as a single pool of seamless resources when accessed by elements of data processing environment 100, such as in a cloud computing environment. In general, server device 130 is representative of any electronic device or combination of electronic devices capable of executing computer readable program instructions. Server device 130 can include components as depicted and described in further detail with respect to FIG. 3, in accordance with embodiments of the present invention.

In embodiments, server device 130 includes emotion program 132 and information repository 134. Emotion program 132 is a program, application, or subprogram of a larger program for annotating text based on the emotive content of the text and machine learning models. In an embodiment, emotion program 132 annotates text communication between messaging program 112 and messaging program 122. In an alternative embodiment, emotion program 132 may be found on sending device 110, receiving device 120, or any other devices connected to network 102. Information repository 134 includes information used by emotion program 132 for modeling text annotation using emotive correlation and updating the models. In an alternative embodiment, information repository may be found on sending device 110, receiving device 120, or any other devices connected to network 102.

In an embodiment, emotion program 132 is a program that receives text input by a user on a messaging program, predicts annotated text based on correlations between text input and emotions using a machine learning model, receives an indication from a user as to the accuracy of the annotated text, and updates the machine learning model accordingly. In other words, emotion program 132 receives a text input, by a user, from messaging program 112, predicts annotation to the text using the machine learning model, notifies the user of the annotated text and receives a response as to the accuracy of the annotated text, and updates the machine learning model accordingly. In an embodiment, emotion program 132 may use a machine learning model for every user. In an alternative embodiment, emotion program 132 may have an individual machine learning model associated with each user. In an embodiment, emotion program 132 starts with standard machine learning model for a new user and updates the machine learning model based on indications from the user. In an embodiment, emotion program 132 receives text input from the user. In an embodiment, emotion program 132 analyzes the text. In an embodiment, emotion program 132 determines the emotive content of the text. In an embodiment, emotion program 132 annotates the text based on the determined emotive content. In an embodiment, emotion program 132 determines if the annotated text is correct based on an input from the user. In an embodiment, if the indication from the user is that the annotated text is correct, emotion program 132 sends the annotated message. In an embodiment, if the indication from the user is that the annotated text is not correct, emotion program 132 updates the machine learning model based on the indication.

A machine learning model includes the construction and implementation of algorithms that can learn from and make predictions on data. The algorithms operate by building a model from example inputs in order to make data-drive predictions or decisions, rather than following strictly static program instructions. In an embodiment, the model is a system which explains the behavior of some system, generally at the level where some alteration of the model predicts some alteration of the real-world system. In an embodiment, a machine learning model may be used in a case where the data becomes available in a sequential fashion, in order to determine a mapping from the dataset to corresponding labels. In an embodiment, the goal of the machine learning model is to minimize some performance criteria using a loss function. In an embodiment, the goal of the machine learning model is to minimize the number of mistakes when dealing with classification problems. In yet another embodiment, the machine learning model may be any other model known in the art.

In an embodiment, information repository 134 may include information about a standard machine learning model that can be applied on an ongoing basis. In an embodiment, the standard machine learning model is trained from the interaction with all previous users of emotion program 132. In an alternative embodiment, information repository 134 may include multiple machine learning models, where each machine learning model is for a specific user and the machine learning model has been updated for the interaction of each specific user the machine learning model is associated with. In an embodiment, information repository 134 may include features defining the typing characteristics of a user and a correlation of emotive content to the typing characteristics. The typing characteristics include but are not limited to, key press duration, duration between key presses, capitalization of text, frequency of capitalization of text, prevalence of spelling errors, average word length, etc.

Information repository 134 may be implemented using any volatile or non-volatile storage media for storing information, as known in the art. For example, information repository 134 may be implemented with a tape library, optical library, one or more independent hard disk drives, or multiple hard disk drives in a redundant array of independent disks (RAID). Similarly, information repository 134 may be implemented with any suitable storage architecture known in the art, such as a relational database, an object-oriented database, or one or more tables.

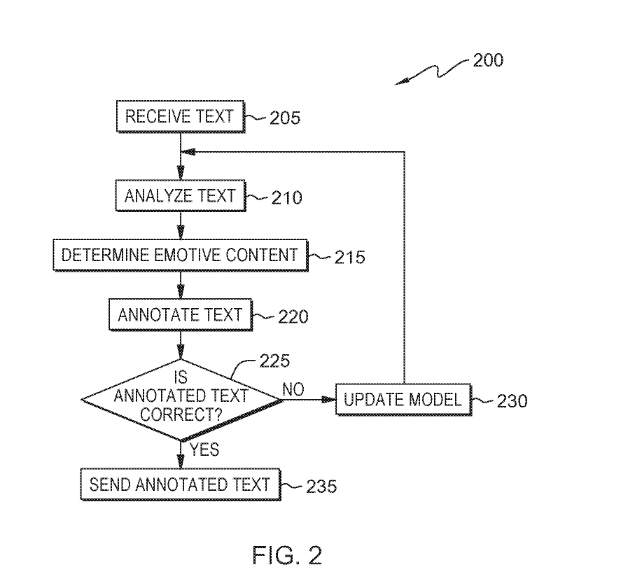

FIG. 2 is a flowchart of workflow 200 depicting operational steps for annotating natural language text based on the emotive content of the natural language text using machine learning models, in accordance with an embodiment of the present invention. In one embodiment, the steps of the workflow are performed by emotion program 132. Alternatively, steps of the workflow can be performed by messaging program 112 or messaging program 122 while working with emotion program 132. In yet another alternative, steps of the workflow can be performed by any other program while working with emotion program 132. In an embodiment, emotion program 132 can invoke workflow 200 upon receiving a request to annotate text in a messaging program in real time. In an alternative embodiment, emotion program can invoke workflow 200 upon receiving electronic text to be annotated.

Emotion program 132 receives text (step 205). In other words, emotion program 132 receives text from messaging program 112 that is input by a user. In an embodiment, the received text from messaging program 112 is going to be sent to another user of messaging program 122. In an embodiment, emotion program 132 may receive the text from messaging program 112 as the user is inputting the text (i.e., real time). In other words, emotion program 132 may receive words in a sentence or partially completed words. In an alternative embodiment, emotion program 132 may receive text from messaging program 112 upon a user completing a message and the user sending the message. In an embodiment, the text may be a natural language text. In an embodiment, the text include the typing characteristics of the text. For example, a first user is remotely diagnosing technical issues of a laptop of a second user. The first user communicates to the second user the text “delete the root directory from your computer.” The communication from the first user is joking and sarcastic. If the second user were to delete the root directory from the computer the computer would not work.

Emotion program 132 analyzes the text (step 210). In other words, emotion program 132 analyzes the received natural language text and the typing characteristics used for the natural language text. The typing characteristics are how the user has typed the message when the message was being input into messaging program 112. In an embodiment, typing characteristics can be key press duration (i.e., how long a key is pressed), duration between key presses, capitalization of text, frequency of capitalization of text, prevalence of spelling errors, average word length, previously deleted text, etc. The typing characteristics may be attached as metadata that is transmitted with the text. For example, the typing characteristics of the user when typing the text “delete the root directory from your computer,” include long durations between key presses and the first word of the sentence was capitalized.

Emotion program 132 determines the emotive content (step 215). In other words, emotion program 132 uses the machine learning model and the typing characteristics of the user to determine the emotive content of the natural language text. In an embodiment, emotion program 132 may use the standard machine learning model (i.e. a machine learning model that is used for a large group of people). In an alternative embodiment, emotion program 132 may use an updated machine learning model that is specific to the user that has typed the text. The updated machine learning model has been updated based on previous emotive content predictions by the machine learning model and responses from the user as to the accuracy of the previous emotive content predictions. In an embodiment, the emotive content may be levity, seriousness, happiness, sadness, anger, sarcastic, tears, surprise, etc. For example, the standard machine learning model correlates long durations between key presses along with not capitalizing the first word in a sentence with a joking or sarcastic emotive content.

Emotion program 132 annotates the text (step 220). In other words, emotion program 132 modifies the natural language text to include a form of emotive content that was determined previously. In an embodiment, modifications may include inserting emoticons, pictures, audio, video, or any other media known in the art. In another embodiment, modifications may include a metacommunicative pictorial representation of a facial expression or other body expression, in the absence of actual body language and prosody that serves to draw attention to the tenor or temper of a message by changing or improving the interpretation of the message by the person who receives the message. In an embodiment, the annotated text may include all, some, or none of the original text. In an embodiment, the annotated text may include text that describes an emotion. In an embodiment, the annotate text may include coloring or modifying the font of the text (i.e., bold, underline, italics, etc.). For example, the text “delete the root directory from your computer” that includes a joking or sarcastic emotive content is annotated to also include an emoticon that is a face smirking and an emoticon that is a face laughing. In another example, the text “delete the root direction from your computer” that includes a joking or sarcastic emotive content is annotated to also include text “This is a joke” and the annotated text is in italics and colored yellow.

Emotion program 132 determines if the annotated text is correct (decision block 225). In other words, emotion program 132 communicates the annotated text that includes the modification to the natural language text to messaging program 112 for verification of accuracy by the user. The user, via the user interface of messaging program 112, discussed previously, views the annotated text to determine the accuracy. Emotion program 132 receives an indication from the user, via messaging program 112, as to the accuracy of the annotated text. In an embodiment, this may be an indication that the annotated text is correct or that the annotated text is not correct. In an alternative embodiment, the indication may include a modification to the annotated text.

If emotion program 132 determines the annotated text is correct (decision block 225, yes branch), emotion program 132 sends the annotated text (step 235). In other words, emotion program 132 receives an indication from the user, via messaging program 112, that the annotated text is correct and emotion program 132 will send the annotated text to messaging program 122 for viewing by another user. For example, the user will indicate, via messaging program 112, that the communication including the text “delete the root directory of your computer” along with the emoticon that is a face smirking and an emoticon that is a face laughing is correct and emotion program 132 will send the full communication (i.e., text and emoticons) to messaging program 122 for the second user to view. In an embodiment, emotion program 132 updates the machine learning model based on the annotation to the natural language text being accurate.

If emotion program 132 determines the annotated text is not correct (decision block 225, no branch), emotion program 132 updates the model (step 230). In other words, emotion program 132 receives an indication from the user, via messaging program 112, that the annotated text is incorrect. Emotion program 132, using information found in the indication, updates the machine learning model based on the indication from the user. In an embodiment, emotion program 132 updates the standard machine learning model. In an alternative embodiment, emotion program 132 updates the machine learning model specific to the user that typed the text and made the indication. For example, the user may indicate that the input text “delete the directory from your computer,” with the emoticon that is a face smirking and an emoticon that is a face laughing is incorrect and emotion program 132 updates the machine learning model for the user. In another example, the user may indicate the input text “delete the directory from your computer,” with the emoticon that is a face smirking and emoticon that is a face laughing is incorrect and the user may remove both emoticons and add an emoticon that a face with a serious look. In this example, the user is indicating the text “delete the directory from your computer,” is a serious statement because the user is adding an emoticon with a serious look and therefore emotion program 132 will update the machine learning model for the user to correlate long durations between key presses along with not capitalizing the first word in a sentence with a serious emotive content.

FIG. 3 depicts computing system 300 that is an example of a computing system that includes messaging program 112, messaging program 122, or emotion program 132. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for annotating natural language text based on an emotive content of the natural language text, the method comprising the steps of:
receiving, by one or more computer processors, a natural language text from a user, wherein the natural language text includes typing characteristics metadata, and wherein the typing characteristics metadata include all of the following: a key press duration; a duration between key presses in the natural language text; a capitalization of the natural language text; a frequency of the capitalization of the natural language text; a set of spelling errors in the natural language text; an average word length in the natural language text; and previously deleted natural language text;
determining, by one or more computer processors, an emotive content of the natural language text using a machine learning model and the typing characteristics metadata, wherein the machine learning model is associated with the user;
determining, by one or more computer processors, an annotation to the natural language text based on the emotive content, wherein the annotation is modifying a font of the natural language text, and wherein the annotation includes all of the following: an emoticon; a picture; an audio; a video; a text that describes the emotive content;
receiving, by one or more computer processors, a first indication from the user that the modification to the natural language text is incorrect;
responsive to receiving the first indication from the user that the modification to the natural language text is incorrect, updating, by one or more computer processors, the machine learning model based on the first indication;
receiving, by one or more computer processors, a second indication from the user that the modification to the natural language text is correct; and
responsive to receiving the second indication from the user that the modification to the natural language text is correct, sending, by one or more computer processors, the annotated text to a second user.
